(19) United States
(12) Patent Application Publication
(10) Pub. No.: US 2005/0260455 A1
(43) Pub. Date: Nov. 24, 2005

(54) Methods of coating titanium dioxide

(76) Inventors: John Haozhong Xin, Kowloon (HK); Walid Abdelhamid Daoud, Kowloon (HK)

Correspondence Address: JACOBSON HOLMAN PLLC, 400 SEVENTH STREET N.W., SUITE 600, WASHINGTON, DC, 20004, US

(21) Appl. No.: 10/849,014

(22) Filed: May 20, 2004

(51) Int. Cl. B32B 9/00

(52) U.S. Cl. 428/702; 427/226

(57) ABSTRACT

Existing methods of coating titanium oxide, like impregnation, may suffer from low adhesion between the coatings and the substrate surface. Further, high temperatures may be required, and may not be suitable to substrates that cannot withstand high temperatures. This invention provides a coating of titanium dioxide to an article. First, a sol mixture is formed by mixing a precursor of titanium dioxide with a solvent at an acidic pH. The sol mixture is then coated onto the article. The method of this invention may coat titanium dioxide onto an article without application of high temperatures. Further, the adhesion between the titanium dioxide and the article may be improved.

### FIELD OF THE INVENTION

This invention relates to methods of coating titanium oxide to articles, particularly those for manufacturing antibacterial coatings.

### BACKGROUND OF THE INVENTION

Existing methods of coating titanium oxide, like impregnation, may suffer from low adhesion between the coatings and the substrate surface. In JP2002138366, a fabric is coated by immersion in a water solution containing titanium fluoro complexes (e.g., titanium potassium fluoride), alkali (sodium carbonate), and organic acids (citric acid and malic acid) for the deposition of titanium oxide onto the surface. In JP2001303434, a slurry is prepared by adding aqueous cationic surfactants (e.g., lauryl trimethylammonium chloride) and photocatalyst particles (average diameter≦300 nm) (e.g., titania ST-01) in an aqueous suspension of aluminosilicates (average diameter 0.01-3 mm) (e.g., Lionite SF). The slurry was then mixed with a binder composition. (Voncoat AB-885) prior to coating. JP09249871 and JP2002069837 applied composites of dispersed titania powder in binders to the surface of a substrate, in which the composite covering layers are formed by applying mixtures, which are formed by mixing aqueous dispersions of titania powder and binders, on the surfaces of substrates. JP09249871 used fluoropolymer as a binder. In such methods, high temperatures may be required, and may not be suitable to substrates that cannot withstand high temperatures, such as textiles and plastics. Further, solid particles may have poor adhesion with solid surfaces.

### OBJECTS OF THE INVENTION

Therefore, it is an object of this invention to resolve at least one or more of the problems as set forth in the prior art. As a minimum, it is an object of this invention to provide the public with a useful choice.

### SUMMARY OF THE INVENTION

Accordingly, this invention provides a method of providing a coating of titanium dioxide to an article. First, a sol mixture is formed by mixing a precursor of titanium dioxide with a solvent at an acidic pH. The sol mixture is then coated onto the article.

Preferably the precursor of titanium dioxide is selected from the group of titanium alkoxides, titanium nitrates, and titanium halides.

Advantageously, the solvent is alcohol, which may be selected from the group consisting of ethanol, propanol, and butanol. Alternatively, the solvent may be water.

Preferably, the acidic pH is 1 to 2.

Additionally, the article may be dried before dipping in the sol mixture.

The article to be used in this invention can be a textile. For textile articles, it may be preferable to apply a pressure to the article after dipping the article in the sol mixture. Preferably, the pressure is from 1 to 5 kg/cm². Alternatively, the article may be cured after dipping in the sol mixture and applying the pressure.

It is another aspect of this invention to provided an article coated with titanium oxide according to the above methods.

### DETAILED DESCRIPTION OF THE PREFERRED EMBODIMENT

This invention is now described by way of example with reference to the figures in the following paragraphs. List 1 is a part list so that the reference numerals in the figures may be easily referred to.

Objects, features, and aspects of the present invention are disclosed in or are obvious from the following description. It is to be understood by one of ordinary skill in the art that the present discussion is a description of exemplary embodiments only, and is not intended as limiting the broader aspects of the present invention, which broader aspects are embodied in the exemplary constructions.

The method of coating titanium oxides to an article according to this invention may be divided into two steps. The first step involves the forming of a sol mixture of titanium oxide by mixing the titanium compound with a solvent at an acidic pH. The article is then “dipped” into the sol mixture. If the article is a textile, then a pressure is applied to the article after being dipped into the sol mixture. It is found that the resulting coating may maintain its properties even after 55 cycles through laundry process for textiles substrates. Further, heating may not be required during the process. The method of this invention is found to be applicable to various substrates including textiles, plastics, and so on.

The term “dipped” used throughout the specification means “to put briefly into a liquid” so that the sol mixture can be in contact with the coating surface of the article.

The titanium compound used in the making of the sol mixture can be various precursors of titanium dioxide, for example, titanium alkoxides, such as titanium tetraisoproxide, titanium tetrabutoxide; titanium nitrate; titanium halides, such as titanium chloride.

The solvent used in this invention is to provide a suspending medium. The solvent can react with the alkoxides as in case of ethanol with titaniumtetraisopropoxide to give titanium tetraethoxide. This may accelerates the hydrolysis step of the alkoxide group to give hydroxide product. Absolute ethanol may be a preferred choice due to price and availability consideration, but of course other alcohols can be used.

Alternatively, water can also be used to replace alcohol as the solvent. In this case, a direct hydrolysis of the alkoxides occurs to produce hydroxide compounds. This is followed by a polycondensation reaction to titanium oxide product.

Acids may be used to maintain the pH of the sol mixture at low pH, say, pH 1 to 2. Concentrated hydrochloric or nitric acid may be used, for example. Organic acids like acetic acid may also be used as the acidic media.

The sol mixture may be prepared, at room temperature, by mixing the titanium dioxide precursor with the alcohol. The mixture is then stirred for a period of time prior to coating. Ten minutes of stirring time was found to be sufficient for ethanol as the suspending medium. However if water is used, the reaction time is preferred to be between 18-22 hours in order to produce a translucent sol. The following equations may summarize the principal reactions involved:
Ti(OPr)₄+4 EtOH→Ti(OEt)₄+4 PrOH
Ti(OPr)₄ or Ti(OEt)₄+H₂O→Ti(OH)₄+4 PROH or 4 EtOH
Ti(OH)₄→TiO₂+2H₂O

The article is then dipped in the sol mixture. After the dipping process, a portion of the sol mixture will remain on the article. If the article or substrate is a textile, the sol mixture is then pressed onto the article by applying a pressure to the coated article. The pressure may be applied by, for example, an automatic padder. A nip pressure of about 1 to 5 kg/cm² was found to be sufficient, which may be a common figure for padding of treated fabrics.

Alternatively, “doctor blading” (as described in Tape Casting: Past, Present, Potential, Richard E. Mistler, American Ceramic Society Bulletin, October 1998), spin coating or solvent casting techniques may be used to coat the sol mixture onto the substrates like plastic, glass or metal.

It may be preferable to dry the article at an elevated temperature before dipping in the sol mixture, for example, at about 100° C. for 30 minutes. After the article is pressed with the sol mixture, it may be preferable to dry the pressed article, for example, at about 80° C. for 10 minutes, to evaporate the alcohol. The article may then be further cured at a higher temperature, say, about 100° C. These drying prior to coating, and curing after coating steps are purely optional. Further, many factors may influence the temperature and time involved, like the materials of the sol mixture and article, so that the temperature and time involved may have to be determined by trial-and-error. For example, the drying step may involve no heating if desired.

Two examples of one of the specific embodiments will be described in the following section.

### EXAMPLE 1

1 Sol Mixture Preparation

The sol mixture, or nanosol, was prepared at room temperature by mixing titanium tetraisopropoxide (Aldrich, 97%) with absolute ethanol (Riedel, 99.8%) at pH of 1 to 2. The mixture was vigorously stirred for 10 minutes prior to coating.

2 Padding process

A 10×10 cm knitted cotton substrate was dried at 100° C. for 30 minutes, dipped in the nanosol for 30 seconds and then padded using an automatic padder at a nip pressure of 2.75 kg/cm². The padded substrates were then dried at 80° C. for 10 minutes in a preheated oven to drive off ethanol and finally cured at 100° C. in a preheated curing oven. The drying prior to coating step and the curing after coating step are optional.

3 Antibacterial Activity

The antibacterial activities of the treated fabric were qualitatively assessed by an antibacterial activity test where 2.5×5 cm specimens of treated and untreated cotton were placed in an intimate contact across streaks of klebsiella pneumoniae gram negative bacteria organism that were made parallel and 10 mm apart on agar plates. The plates were incubated for 24 hours at 37° C. under ambient cool white fluorescent light similar to normal office lighting. The incubated plates were then examined for interruption of growth. The clear zone beneath the specimen of coated fabric reveals an almost complete killing of the seeded bacteria, whereas there was a continuing growth of the bacteria beneath the untreated fabric specimen. This is in agreement with previous studies which showed that the antibacterial effect of TiO₂ coated materials involve not only the nullification of the viability of the bacteria, but also the destruction of the bacteria cell. These results indicate the antibacterial capability of the treated fabric, which is considered to be due to the photocatalytic effect of the titania films.

4 Washfastness Test

Samples prepared using the general procedure were found to maintain their properties after having been subjected to 55 washes through a home laundry machine. The antibacterial activities of a coated and washed fabric showed no deterioration in the antibacterial activities. This is considered to be due to the formation of covalent bonding resulting from a dehydration reaction between the hydroxyl groups of cotton and the hydroxyl groups of titania. However, this may be a speculation at this time and further evidence may be required.

### EXAMPLE 2

1 Sol Mixture Preparation

The nanosol was prepared at room temperature by mixing titanium tetraisopropoxide with acidic water containing nitric acid. The mixture was vigorously stirred for 18 hours prior to coating.

2 Padding Process

The fabric substrate was scoured, dried, dipped in the nanosol for 1 minute and then padded using an automatic padder at a nip pressure of 2.75 kg/cm². The padded substrates were then rinsed with sodium carbonate solution (1%) and then with water, dried at 80° C. for 10 minutes in a preheated oven to drive off ethanol and finally cured at 100° C. in a preheated curing oven. The drying prior to coating step and the curing after coating step are optional.

Characterization

1 Antibacterial Activity

The antibacterial activities of the treated fabric were qualitatively assessed by an antibacterial activity test where 2.5×5 cm specimens of treated and untreated cotton were placed in an intimate contact across streaks of klebsiella pneumoniae gram negative bacteria organism that were made parallel and 10 mm apart on agar plates. The plates were incubated for 24 hours at 37° C. under ambient cool white fluorescent light similar to normal office lighting. The incubated plates were then examined for interruption of growth. The clear zone beneath the specimen of coated fabric reveals an almost complete killing of the seeded bacteria, whereas there was a continuing growth of the bacteria beneath the untreated fabric specimen. This is in agreement with previous studies which showed that the antibacterial effect of TiO₂ coated materials involve not only the nullification of the viability of the bacteria, but also the destruction of the bacteria cell. These results indicate the antibacterial capability of the treated fabric, which is considered to be due to the photocatalytic effect of the titania films.

2 Washfastness Test

Samples prepared using the general procedure were found to maintain their properties after having been subjected to 55 washings through a home laundry machine. The antibacterial activities of a coated and washed fabric showed no deterioration in the antibacterial activities. This is considered to be due to the formation of covalent bonding resulting from a dehydration reaction between the hydroxyl groups of cotton and the hydroxyl groups of titania. However, this may be a speculation at this time and further evidence may be required.

This invention may have provided a method of coating titanium dioxide onto an article without application of high temperatures. Further, this method may have improved the adhesion between the titanium dioxide and the article.

As it is known in the art that titanium dioxide coatings also have ultraviolet filtering, self-cleaning, antibacterial and deodorising characteristics, the titanium dioxide coatings and the resulting articles may also have the above properties (Special Issue on Sol-Gel Processed TiO₂-Based Materials for Solar Cells, Photocatalysts and Other Applications, Editor: Sumio Sakka, Publisher: Kluwer, Norwell, Mass., USA, J. Sol-gel Sci Technol., pp 179, 2001).

While the preferred embodiment of the present invention has been described in detail by the examples, it is apparent that modifications and adaptations of the present invention will occur to those skilled in the art. Furthermore, the embodiments of the present invention shall not be interpreted to be restricted by the examples or figures only. It is to be expressly understood, however, that such modifications and adaptations are within the scope of the present invention, as set forth in the following claims. For instance, features illustrated or described as part of one embodiment can be used on another embodiment to yield a still further embodiment. Thus, it is intended that the present invention cover such modifications and variations as come within the scope of the claims and their equivalents.

1. A method of providing a coating of titanium dioxide to an article including the steps of:
forming a sol mixture by mixing a precursor of titanium dioxide with a solvent at an acidic pH;
coating the sol mixture onto the article.

2. The method of claim 1, wherein the precursor of titanium dioxide is selected from the group of titanium alkoxides, titanium nitrates, and titanium halides.

3. The method of claim 1, wherein the solvent is alcohol.

4. The method of claim 3, wherein the alcohol is selected from the group consisting of ethanol, propanol, and butanol.

5. The method of claim 1, wherein the solvent is water.

6. The method of claim 1, wherein the acidic pH is 1 to 2.

7. The method of claim 1 further including the step of drying the article before dipping in the sol mixture.

8. The method of claim 1, wherein the article is a textile.

9. The method of claim 8 further including the step of applying a pressure to the article after dipping the article in the sol mixture.

10. The method claim 9, wherein the pressure is from 1 to 5 kg/cm².

11. The method of claim 8 further including the step of curing the article after dipping in the sol mixture and applying the pressure.

12. An article coated with titanium oxide according to the method of claim 1.
